(19) United States
(12) Patent Application Publication
(10) Pub. No.: US 2025/0371383 A1
(43) Pub. Date: Dec. 4, 2025

(54) MANAGING INFERENCE MODELS USING CONCEPT-BASED REPRESENTATIONS OF INFERENCES

(71) Applicant: Dell Products L.P., Round Rock, TX (US)

(72) Inventors: OFIR EZRIELEV, Beer Sheva (IL); TOMER KUSHNIR, Omer (IL); AMIHAI SAVIR, Newton, MA (US)

(21) Appl. No.: 18/678,530

(22) Filed: May 30, 2024

(51) Int. Cl. G06N 5/04

(52) U.S. Cl. CPC G06N 5/04

(57) ABSTRACT

Methods and systems for managing a generative inference model are disclosed. Using the generative inference model and ingest data, an inference may be obtained. To determine whether the inference is acceptable (e.g., for downstream use, in view of reference works), a set of concepts displayed by the inference may be used to obtain a structured representation of the inference. A comparison process may be performed using the structured representation of the inference and structured representations of the reference works to obtain a level of similarity between the inference and the reference works. Acceptability of the inference may be determined based on the level of similarity and a similarity threshold. If the inference is unacceptable, performance of an action set may be initiated to manage an impact of the level of similarity between the inference and the reference works.

### FIELD

Embodiments disclosed herein relate generally to inference models (e.g., artificial intelligence models). More particularly, embodiments disclosed herein relate to systems and methods to manage generative inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show data flow diagrams in accordance with an embodiment.

FIG. 3 shows an example of a structured representation of an inference in accordance with an embodiment.

FIG. 4 shows a flow diagram illustrating a method in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. The inference models may be used to provide computer-implemented services (e.g., inference generation) for downstream consumers and/or may facilitate computer-implemented services provided by the downstream consumers. For example, the inference models may include generative inference models, which may be used to infer new instances of data when provided with ingest data (e.g., a prompt).

To provide the computer-implemented services, the inference models may be trained using training data. For example, to train a generative inference model to produce unstructured data such as essays, stories, and/or other types of human interpretable text in response to a prompt, the training data may include existing works of various authors (e.g., counts of historical events, fiction, essays, scientific papers, etc.).

However, depending on a variety of factors (e.g., constraints of the prompt, training data variety, inference model capabilities, etc.), an inference generated using the generative inference model may be substantially similar to (or same as) portions of reference works (e.g., the training data, the ingest data, and/or other data). In such cases, downstream use of the inference may lead to issues such as copyright infringement, plagiarism, and/or other types of noncompliant use of the inference model with respect to laws, regulations, or policies. To identify such inferences, comparisons between the inference and the reference works may be made to determine whether similarities between the inference and portions of the reference works constitute plagiarism and/or copyright infringement. However, any similarities between the inference and the reference works may be difficult to measure by virtue of the inference and the reference works including (potentially large volumes of) unstructured data.

Therefore, to improve the likelihood of compliant use of generative inference models, structured representations of the inferences obtained using the generative inference models may be analyzed to identify instances of noncompliance (e.g., plagiarism, copyright infringement) of the inferences. To do so, the structured representations of the inferences may be obtained based on concepts displayed by the inference. For example, an inference may indicate locations, characters, objects, laws of nature, and/or other concepts that may represent characteristics of the inference. Structured representations of the reference works may be obtained in a similar manner for comparison with the structured representation of the inference.

The structured representations may provide for a means of measuring (e.g., qualitatively and/or quantitatively) similarity between the inference and the reference works. For example, a level of similarity between the inference and the reference works may indicate a likelihood that the inference plagiarizes the reference works or that the inference infringes copyrighted materials of the reference works. Thus, when compared to a threshold, the level of similarity may indicate whether the inference is acceptable for downstream use (e.g., compliant with laws, regulations, and/or policies).

By doing so, inferences that are unacceptable for downstream use (e.g., in view of plagiarism, copyright infringement) may be identified, and actions may be initiated in order to manage associated potential impacts.

Thus, embodiments disclosed herein may address, among others, the technical problem of managing copyright infringement and/or plagiarism facilitated by generative inference models with respect to reference works. By managing impacts of similarities between the inferences and the reference works, the generative inference models may be more likely to provide the desired (e.g., legally compliant) computer-implemented services.

In an embodiment, a method for managing a generative inference model is provided. The method may include: obtaining an inference generated using the generative inference model and ingest data; analyzing the inference using a schema to obtain a set of concepts displayed by the inference; obtaining a structured representation of the inference based on the set of concepts; performing a comparison process using the structured representation of the inference and structured representations of reference works to obtain a level of similarity between the inference and the reference works; and, making a determination regarding whether the inference is acceptable based on the level of similarity and a similarity threshold.

In a first instance of the determination where the inference is acceptable, the method may include providing the inference to a downstream consumer as a computer-implemented service.

In a second instance of the determination where the inference is unacceptable, the method may include initiating performance of an action set to manage an impact of the level of similarity between the inference and the reference works.

The generative inference model may be trained to generate human interpretable text when prompted using the ingest data, the human interpretable text being responsive to a request indicated by the ingest data.

The schema may be adapted to facilitate identification of at least one of: a location indicated by the inference; a character indicated by the inference; an object indicated by the inference; and, a law of nature indicated by the inference.

The structured representation of the inference may include a graph-structured data model that specifies relationships between concepts of the set of concepts, the graph-structured data model including nodes and edges, and the edges being based on the relationships between the concepts associated with the edges.

Performing the comparison process may include performing a sub-graph analysis of the structured representation of the inference with respect to portions of the structured representations of the reference works to identify whether a portion of the structured representation of the inference substantially matches one of the portions of the structured representations of the reference works.

The method may further include, prior to performing the comparison process, and for a portion of the reference works: analyzing the portion of the reference works to obtain a set of concepts associated with the portion of the reference works; and, obtaining a structured representation of the portion of the reference works based on the set of concepts associated with the portion of the reference works.

The level of similarity may indicate a likelihood that the inference plagiarizes the reference works.

The action set may include obtaining a description of similarities between the inference and the reference works. The action set may include preventing provision of the inference to the downstream consumers. The action set may include at least one action that, when performed, modifies operation and/or use of the generative inference model to reduce a likelihood that a future inference generated using the generative inference model and the ingest data plagiarizes the reference works.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

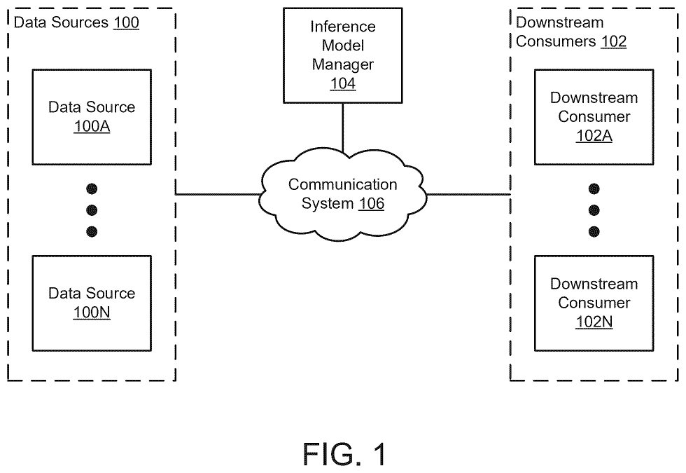

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences obtained using the inference models.

To provide the computer-implemented services, the inference models may be trained, using training data, to generate inferences when provided with a prompt (e.g., ingest data). The inference models may include generative inference models; therefore, the inferences may include new instances of data created by the generative inference models based on learned associations from and/or an understanding of the training data. For example, the inference models may be trained using unstructured data, such as stories, essays, audio transcription, video description, and/or other types of human interpretable text, to generate inferences of the same. The inferences may be provided to downstream consumers as a computer-implemented service and/or in order to facilitate computer-implemented services provided by the downstream consumers.

However, inferences obtained using the generative inference models may be (intentionally or unintentionally) similar to reference works (e.g., the training data, the ingest data, and/or other data, such as derived data). For example, an inference generated by the generative inference model may be similar to a portion of the reference works to an extent that constitutes plagiarism, copyright infringement, and/or other types of prohibited use of the inference with respect to the reference works.

Downstream use of the (prohibited) inference may lead to legal and/or regulatory issues that may negatively impact an operator of the generative inference model, users of the generative inference model (e.g., downstream consumers of the inference), and/or the computer-implemented services provided using the generative inference model. In other words, distribution and/or use of the inference may be out of compliance with laws, regulations, policies, and/or guidelines, which may prevent the provision of desired (e.g., legally compliant) computer-implemented services.

In general, embodiments disclosed herein may provide methods, systems, and/or devices for managing generative inference models in a manner that increases a likelihood of providing the desired computer-implemented services. To do so, inferences obtained using the generative inference models may be analyzed in order to obtain concepts associated with (e.g., displayed by, exhibited by) the inferences. The concepts may include portions of the inference (e.g., a portion of text) that are identifiable by a person but are not explicitly described as concepts in the output. For example, the concepts may include an object indicated by the inference, a character indicated by the inference, a location indicated by the inference, a law of nature indicated by the inference, etc. The concepts may be used to build a structured representation of the inference, such as a graph-structured data model.

Structured representations of reference works for the generative inference model may be obtained in a similar fashion for comparison with the structured representation of the inference. As the inference and the reference works may include unstructured data, by obtaining their structured representations, a means for quantitative evaluation of similarities between the inference and the reference works may be provided. The quantitative evaluation may be used to predict a likelihood of use of the inference being prohibited with respect to the reference works.

By doing so, embodiments disclosed herein may improve identification of similarities between the inferences and the reference works so that potential noncompliance of computer-implemented services may be identified and mitigated timely. The system may do so by initiating performance of actions in order to manage impacts of the similarities.

To provide the above noted functionality, the system of FIG. 1 may include data sources 100, downstream consumers 102, inference model manager 104, and communication system 106. Each of these components is discussed below.

Data sources 100 may include any type and/or number of data sources (e.g., 100A, 100N). Each data source of data sources 100 may include hardware and/or software components configured to obtain data, store data, provide data to other entities, and/or to perform any other task to facilitate performance of the computer-implemented services. All, or a portion, of data sources 100 may provide (and/or participate in and/or support the) computer-implemented services to various devices operably connected to data sources 100. Different data sources may provide similar and/or different computer-implemented services.

For example, data sources 100 may be used to obtain (i) training data usable to train inference models (e.g., generative inference models), (ii) ingest data usable to prompt inference models to generate an inference, and/or (iii) other data (e.g., reference works). Data sources 100 may include data repositories (e.g., training data repositories, reference works repositories), and may provide data to (e.g., allow access to data by) inference model manager 104.

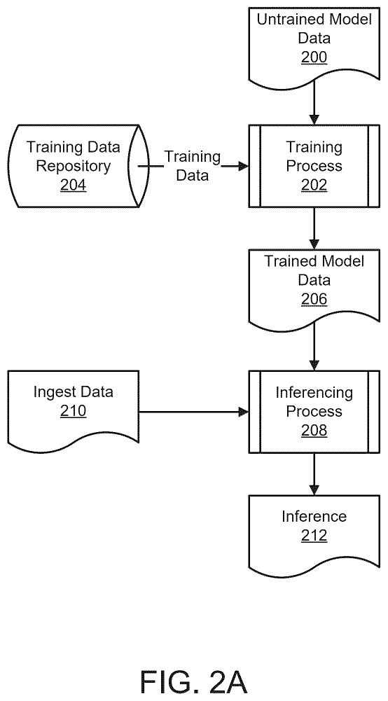

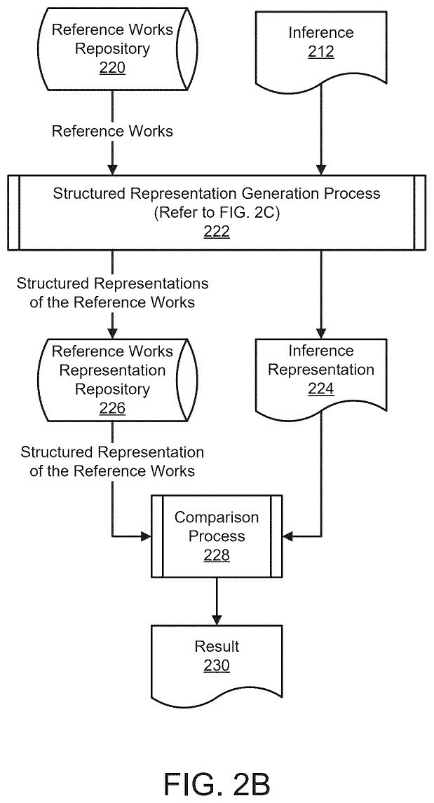

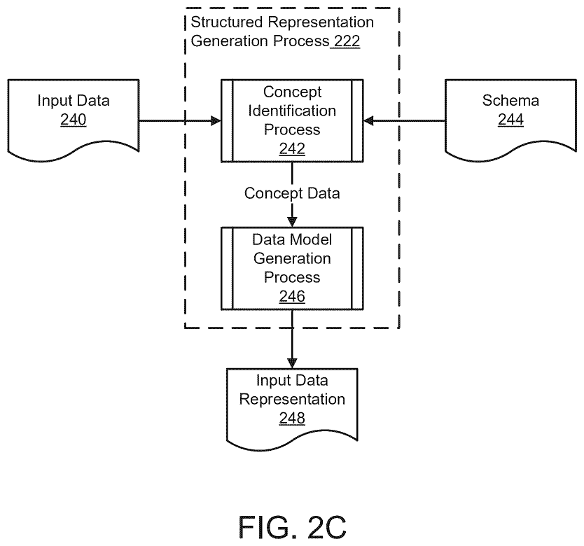

Inference model manager 104 may perform tasks relating to management of and/or facilitation of use of inference models. For example, inference model manager 104 may manage (e.g., facilitate) training processes for the inference models, inferencing processes using the inference models, and/or distribution of inferences obtained using the inference models to downstream consumers 102. Refer to the discussion of FIG. 2A for more information regarding training and/or inferencing processes.

Downstream consumers 102 may provide and/or consume all, or a portion of, the computer-implemented services. Downstream consumers 102 may include any number of downstream consumers (e.g., 102A, 102N) and may include, for example, businesses, individuals, and/or computers that may use inference data to improve decision-making and/or automate tasks. Downstream consumers 102 may subscribe to services using, in part, inference models managed by inference model manager 104. For example, downstream consumers 102 may provide prompts (e.g., ingest data) to generative inference models, and consume inferences (e.g., instances of new data) generated in response to the prompts.

To manage potential similarities between inferences (e.g., obtained using generative inference models) and reference works, inference model manager 104 may (i) analyze inferences (and reference works) in order to obtain sets of concepts that may describe the inferences (and the reference works), (ii) obtain structured representations of the inferences (and the reference works) based on the concepts, (iii) perform comparison processes between the structured representations of the inferences and the structured representations of the reference works to obtain levels of similarity between the inferences and the reference works, (iv) determine acceptability if the inferences based on the levels of similarity, and based on the determination of acceptability, (v) initiate performance of actions relating to inference management, inference model management, and/or detection of noncompliance (e.g., plagiarism, copyright infringement). Refer to the discussion of FIGS. 2B-2C for more information regarding generation and comparison of structured representations.

When providing their functionality, any of (and/or components thereof) data sources 100, downstream consumers 102, and/or inference model manager 104 may perform all, or a portion, of the actions and methods illustrated in FIGS. 2A-4.

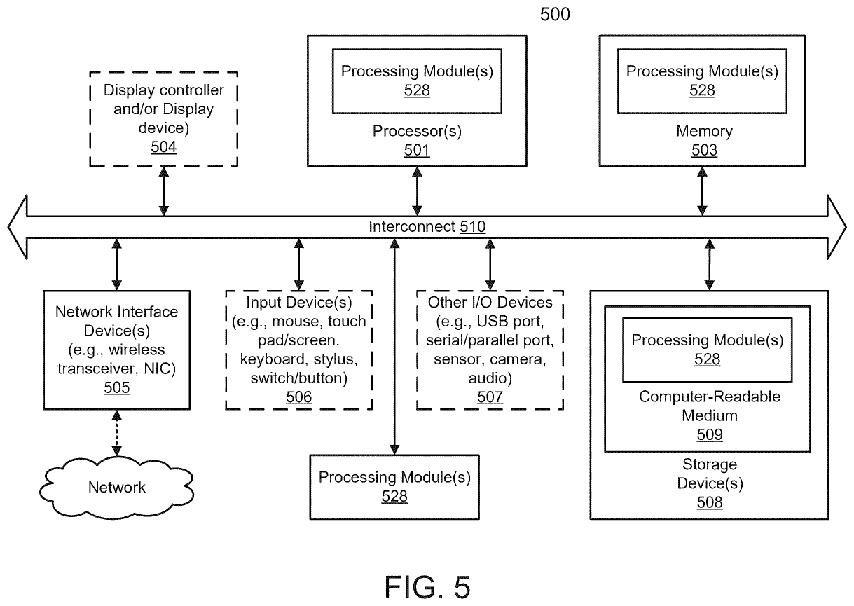

Any of (and/or components thereof) data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 5.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 206, etc.) is used to represent data structures, a second set of shapes (e.g., 202, 208, etc.) is used to represent processes performed using and/or that generate data, and a third set of shapes (e.g., 204, 220, etc.) is used to represent large scale data structures such as databases.

Turning to FIG. 2A, a first data flow diagram in accordance with an embodiment is shown. The first data flow diagram may illustrate data used in and data processing performed when facilitating operation of an inference model. In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using an inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a generative inference model that utilizes a transformer architecture.

During training process 202, untrained model data 200 may be updated using training data from training data repository 204. The training data stored in training data repository 204 may be obtained from any number of data sources (e.g., 100). For example, if the inference model is being trained for text generation, the training data may include a corpus of labeled text samples. As the inference model is exposed to large numbers of relationships and/or patterns in the training data, attention mechanisms, weights and/or other parameters of untrained model data 200 may be modified to obtain trained model data 206. Trained model data 206 may be used during inferencing processes to generate inferences in response to ingest data.

To manage trained inference models, trained model data 206 may be stored in a trained model repository (not shown). For example, trained model data 206 may include inference model data (e.g., information regarding the architecture and/or hyperparameters of the inference model) and/or model parameter values of the inference model (e.g., weights). The trained model repository may store and/or provide access to any number of inference models (e.g., trained model data). For example, access to trained model data 206 may be provided to facilitate performance of inferencing process 208.

During inferencing process 208, a trained inference model may be obtained based on information (e.g., node information, weight information, connection information, activation functions, attention mechanisms, etc.) included in trained model data 206. Inferencing process 208 may include generating inferences based on ingest data 210.

Ingest data 210 may include a portion of data for which an inference is desired to be obtained. For example, ingest data 210 may include a prompt (e.g., a request) obtained from a downstream consumer (e.g., of downstream consumers 102) and/or another data source (e.g., of data sources 100). Ingest data 210 may not include labeled data and, thus, an association for ingest data 210 may not be known. During inferencing process 208, the trained inference model may read ingest data 210 and predict an output likely to be associated with the input (e.g., generate an inference).

For example, ingest data 210 may include a text-based (e.g., human interpretable text) prompt and inference 212 may include different human interpretable text that is likely to be associated with ingest data 210 according to relationships and/or patterns learned by the trained inference model during training process 202. During inferencing process 208, inference 212 may be obtained. Inference 212 may be provided to downstream consumers (e.g., 104) as a computer-implemented service and/or to facilitate further computer-implemented services.

Thus, using the data flows shown in FIG. 2A, computer-implemented services may be facilitated using trained inference models via inference generation. However, the inferences generated by trained inference models may be subject to compliance with laws, regulations, etc., and therefore may be screened for such compliance prior to being made available for downstream use. By doing so, negative impacts associated with noncompliance may be prevented and/or mitigated. Methods for screening inferences obtained using (generative) inference models may be discussed with respect to FIGS. 2B-2C.

Turning to FIG. 2B, a second data flow diagram in accordance with an embodiment is shown. The second data flow diagram may illustrate data used in and data processing performed during screening of inferences for similarities to reference works. The inferences may be screened for similarities to the reference works using structured representations of data.

To obtain the structured representations, structured representation generation process 222 may be performed. During structured representation generation process 222, structured representations of reference works from reference works repository 220 and a structured representation of inference 212 may be obtained. As discussed with respect to FIG. 2A, inference 212 may be obtained during an inferencing process using a generative inference model in response to ingest data.

During structured representation generation process 222, reference works from reference works repository 220 may be identified and/or selected. For example, all or a subset of reference works from reference works repository 220 may be selected. Reference works repository 220 may include training data used to train the generative inference model, data derived from the training data, and/or other data (e.g., ingest data). For example, if the generative inference model is a text-based generative inference model, then the reference works selected from reference works repository 220 may include training samples of text (e.g., samples used to train the generative inference model), samples of text derived from the training samples, and/or other relevant samples of text (e.g., of the same and/or similar topic, by the same and/or similar author).

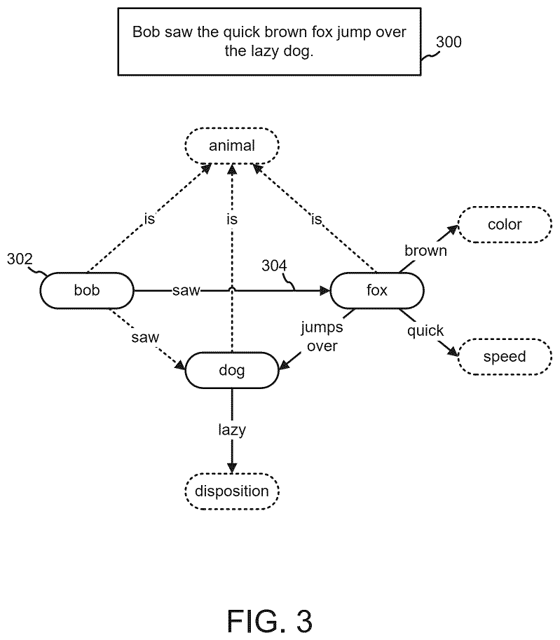

Structured representation generation process 222 may include any types of processes for interpreting text-based data (e.g., human interpretable text) such that a structured data model may be derived from the interpretation. For example, during structured representation generation process 222, concepts displayed by input data (e.g., inference 212, portions of reference works) may be identified, and structured data models may be generated for the input data based on the identified concepts. For example, the structured data models may include graph-structured data models. Refer to the discussion of FIG. 2C for an example of a structured representation generation process. Refer to FIG. 3 for an example graph-structured data model.

During structured representation generation process 222, structured representations of the reference works may be obtained based on concepts of (portions of) reference works, and/or inference representation 224 may be obtained based on concepts of inference 212. Inference representation 224 may include a structured representation of inference 212.

Any of the structured representations of the reference works obtained during structured representation generation process 222 or from other similar processes may be stored in reference works representation repository 226. For example, portions of the structured representations of the reference works stored in reference works representation repository 226 may have been obtained prior to obtaining inference 212 and/or prior to obtaining the structured representation of inference 212.

Reference works representation repository 226 may store any number and/or type of structured representations of reference works. The structured representations of the reference works may be stored with identifiers and/or other information usable to identify and/or select structured representations for use by other processes, such as screening inference 212 for similarities to the reference works.

To screen the inferences for similarities to the reference works, comparison process 228 may be performed. During comparison process 228, inference representation 224 and at least one structured representation of the reference works may be compared using any type of data structure comparison algorithm. For example, inference representation 224 may include a graph-structured data model that specifies relationships between concepts of inference 212, and the structured representation of the reference works may include a graph-structured data model that specifies relationships between concepts of the reference works.

The graph-structured data models may include any number of nodes (e.g., that represent concepts displayed by inference 212 or the reference works) and edges connecting the nodes (e.g., that represent relationships between the concepts). In this example, the data structure comparison algorithm may include any type of graph comparison algorithm usable to analyze similarities between the graph-structured data model of inference representation 224 and at least the graph structured data model of the structured representation of the reference works.

During comparison process 228, inference representation 224 and the structured representation of the reference works may be compared at various levels of granularity. For example, structural similarities between two graph-structured data models may be analyzed using methods of alignment to identify portions of the graph-structured data models that may correspond to one another. In other words, a sub-graph analysis of inference representation 224 with respect to the structured representation of the reference works may be performed. For example, matches (or substantial matches, based on a threshold) of sub-structures of the structured data models, semantic relationships, common attributes, and/or combinations thereof may be identified.

Based on the comparisons made during comparison process 228, similarities between inference representation 224 and the structured representation of the reference works may be identified and/or measured. For example, the measurements of similarities may be based on likelihoods of correspondence between identified portions of the graph-structured data models and/or other types of measurements of similarity between two structured data models.

Comparison process 228 may be performed using any number of structured representations of reference works. Based on the comparisons of portions of structured representation of the reference works and inference representation 224, a level of similarity between inference 212 and the reference works may be obtained. The level of similarity may be based on any number of comparisons performed during comparison process 228. For example, the level of similarity may be described using a function of measured similarities between portions of structured representations, and may include a numerical value or a multi-dimensional value (e.g., a vector). The level of similarity may indicate, for example, a likelihood that inference 212 plagiarizes the reference works and/or a likelihood of compliance of inference 212 with facilitating desired computer-implemented services.

During comparison process 228, the level of similarity may be compared to a similarity threshold. The similarity threshold may be based on laws, regulations, policies, historical experience, etc., and may include a value or a multi-dimensional value (e.g., a vector). The level of similarity and the similarity threshold may be compared with one another in order to obtain result 230. Result 230 may indicate whether inference 212 is acceptable (e.g., likely to facilitate desired computer-implemented services), or unacceptable (e.g., not likely to facilitate the desired computer-implemented services).

For example, if the level of similarity does not exceed the similarity threshold, then inference 212 may be likely to be compliant with facilitating the desired computer-implemented services. However, if the level of similarity exceeds the similarity threshold, then inference 212 may be likely to be noncompliant with facilitating the desired computer-implemented services (e.g., inference 212 may be likely to plagiarize the reference works).

Result 230 may be a data structure that includes information regarding screening of inference 212 with respect to the reference works. For example, result 230 may include information that indicates a Boolean (e.g., pass or fail) result of comparison process 228, and/or any information usable for obtaining an action set for managing the level of similarity between inference 212 and the reference works.

For example, if inference 212 is considered acceptable, an action of the action set may include providing the inference to a downstream consumer (as part of a computer-implemented service). Or, for example, if inference 212 is considered unacceptable, then the action set may include (i) obtaining a description of the similarities between the inference and the reference works (e.g., using a knowledge graph to text method, based on similarities identified between structured representations of the inference and the reference works), (ii) flagging the inference as unacceptable in order to prevent provision of the inference to a downstream consumer, and/or (iii) an action that, when performed, modifies operation and/or use of the generative inference model. For example, the generative inference model may be retrained, taken offline, replaced with a different generative inference model, etc., to reduce a likelihood of obtaining or providing future inferences that may be considered unacceptable.

As discussed, to obtain structured representations of inferences and/or reference works for use in screening the inferences for similarities to the reference works, a structured representation generation process may be performed. An example of a structured representation generation process is described with respect to FIG. 2C.

Turning to FIG. 2C, a third data flow diagram in accordance with an embodiment is shown. The third data flow diagram may illustrate data used in and data processing performed to obtain structured representations of text-based data during a structured representation generation process. The structured representations may be concept-based. For example, the structured representations may be generated using a set of concepts exhibited by the text-based data. The data flow shown in FIG. 2C may be an example expansion of structured representation generation process 222 shown in FIG. 2B.

To obtain the set of concepts, concept identification process 242 may be performed. During concept identification process 242, concepts (and their relationships) displayed by input data 240 may be extracted and/or inferred from input data 240. Input data 240 may include unstructured human interpretable text-based data. For example, input data 240 may include an inference (e.g., inference 212), or a portion of reference works (e.g., from reference works repository 220).

During concept identification process 242, various text analysis algorithms may be used to analyze input data 240. The text analysis algorithms may use machine-learning techniques (e.g., natural language processing), rule-based systems, and/or other tools to classify, extract, and/or interpret text of input data 240. For example, a natural language processing inference model (e.g., a topic model) may be used to classify input data 240. Based on the classification, a schema (e.g., schema 244) may be selected to further analyze input data 240. Concept identification process 242 may use schema 244 to identify concepts and/or relationships indicated by input data 240.

Schema 244 may include keywords, predefined tags or categories, and/or other means for rule-based interpretation of unstructured data. For example, schema 244 may be adapted to facilitate identification of concepts displayed by input data 240 such as: locations, characters, objects, laws of nature, situations, ideas, events, and/or abstract concepts that may be indicated by input data 240.

For example, schema 244 may be used to identify concepts from input data, “The unicorn stood in a forest surrounded by tree.” Schema 244 may facilitate identification of “unicorn” as a character, “forest” as a location, “trees” as an object (e.g., objects), and/or the existence of the unicorn may infer “magic” as a law of nature.

Input data 240 may be analyzed at various levels of granularity (e.g., entire documents, single sentences, sub-sentences) using schema 244 to obtain concept data for input data 240. The concept data may include the set of concepts and corresponding relationships identified during concept identification process 242. Concept data may be provided to data model generation process 246 in order to obtain a concept-based structured representation of input data 240.

To obtain the concept-based structured representation, data model generation process 246 may be performed. During data model generation process 246, the concept data may be used to create a structured data model of input data 240 (e.g., input data representation 248). Input data representation 248 may include a graph-structured data model that specifies relationships between concepts of the concept data using a number of nodes interlinked by edges. For example, the nodes may represent concepts of the concept data, and the edges represent relationships of the concept data. The edges may be based on the relationships between the concepts that are associated by the edges. The nodes and/or edges of the graph-structured data model may include complex representations, such as vectors.

Input data representation 248 may be similar to inference representation 224 and/or any structured representation of the reference works described in FIG. 2B. An example of input data representation 248 is shown in FIG. 3.

Turning to FIG. 3, an example of a structured representation in accordance with an embodiment is shown. In FIG. 3, a structured representation of text-based data (e.g., shown in box 300 as, “Bob saw the quick brown fox jump over the lazy dog.”) is shown as a graph-structured data model. The graph-structured data model includes nodes (e.g., represented by shape 302), and edges (e.g., represented by arrow 304) connected the nodes.

The graph-structured data model may specify relationships between concepts of the input data (e.g., the graph-structured data model may be concept-based). For example, the nodes of the graph-structured data model may be based on concepts (e.g., identified during concept identification process 242), and the edges may be based on the relationships (e.g., identified during concept identification process 242) between the concepts associated with the edges.

Some concepts may be identified directly (e.g., extracted) from the input data, such represented by shape 302 drawn in solid lines (e.g., “bob”, “dog”, etc.), whereas other concepts may be inferred from the input data and/or based on other information, such as those represented by shape 302 drawn in dashed lines (e.g., “animal”, “color”, etc.). Similarly, relationships between the concepts may be extracted from the input data (e.g., “lazy”, “quick”, etc.), whereas other relationships between concepts may be inferred. For example, it may be inferred (e.g., with some level of probability) that Bob saw the dog since he saw the fox jump over the dog.

While the graph-structured data model shown in the example of FIG. 3 includes a simple representation of the text-based data shown in box 300, it will be appreciated that structured representations may include more complex representations in practice (e.g., using vector and/or matrix mappings).

The graph-structured data model shown in FIG. 3 may be compared with other graph-structured data models to identify whether portions of the graph-structured data models match one another (e.g., substantially match one another, based on a similarity threshold). For example, a graph-structured data model of input data: “The brown bear slowly stepped over the lazy dog,” may include portions that match the graph-structured data model shown in FIG. 3.

Returning to FIG. 2C, input data representation 248 may include a structured representation of text-based data, such as an inference (e.g., inference 212) and/or a structured representation of reference works for the inference. The structured representations may be compared during a comparison process to identify inferences that are likely to be noncompliant with providing desired computer-implemented services, and action items for managing the likely noncompliance. Refer to the discussion of FIG. 2B for more information regarding use of the structured representations.

Thus, using the data flows shown in FIGS. 2A-2C, generative inference models may be managed using concept-based structured representations of inferences obtained using the generative inferences models. The concept-based structured representations may provide for classification of the inferences as acceptable or unacceptable. Based on the acceptability of the inferences, the generative inference models may be managed to increase the likelihood of providing desired (e.g., compliant) computer-implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

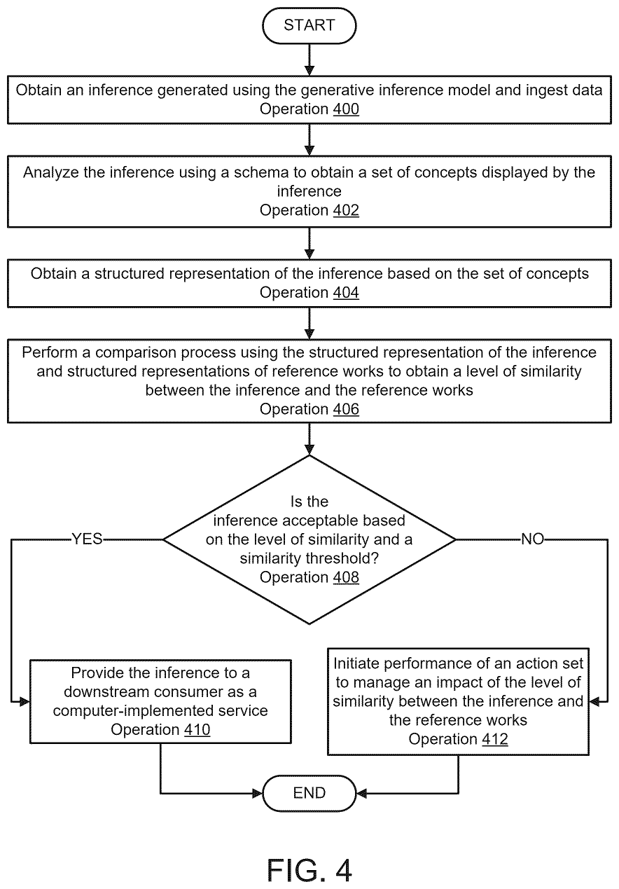

As discussed above, the components of FIG. 1 may perform various methods to manage generative inference models in view of plagiarism and/or copyright infringement. FIG. 4 illustrates a method that may be performed by the components of the system of FIG. 1 and/or by other components. In the diagram discussed below and shown in FIG. 4, any of the operations may be repeated, performed in different orders, and/or performed in parallel with or in a partially overlapping in time manner with other operations.

Turning to FIG. 4, a flow diagram illustrating a method for managing a generative inference model in accordance with an embodiment is shown. The method may be performed by any of the components of the system shown in FIG. 1.

At operation 400, an inference generated using the generative inference model and ingest data may be obtained. The inference may be obtained by (i) reading the inference from storage, (ii) receiving the inference (e.g., from another device), (iii) generating the inference, and/or (iv) via other methods. For example, the inference may be generated by prompting the generative inference model to respond to a request using the ingest data (e.g., as discussed with respect to inferencing process 208 of FIG. 2A). The generative inference model may be trained to generate human interpretable text in response to ingest data; therefore, the inference may include human interpretable text.

At operation 402, the inference may be analyzed using a schema to obtain a set of concepts displayed by the inference. The inference may be analyzed by performing a concept identification process similar to concept identification process 242 of FIG. 2C and/or by other methods. For example, the inference may be analyzed using natural language processing and/or other types of machine-learning techniques and/or using a rule-based system based on the schema. The schema may be adapted to facilitate identification of at least one of: a location, a character, an object, and/or a law of nature, indicated by the inference.

At operation 404, a structured representation of the inference may be obtained based on the set of concepts. The structured representation of the inference may be obtained by (i) reading the structured representation from storage, (ii) receiving the structured representation (e.g., from another device), (iii) generating the structured representation, and/or (iv) via other methods. For example, the structured representation of the inference may be generated by performing a data model generation process similar to data model generation process 246 of FIG. 2C and/or by other methods. The structured representation of the inference may include a graph-structured data model that specifies relationships between concepts of the set of concepts.

Prior to operation 406, structured representations of reference works may be obtained. The structured representations of the reference works may be obtained by, for a (e.g., each) portion of the reference works, (i) analyzing the portion of the reference works to obtain a set of concepts associated with the portion of the reference works, and (ii) obtaining a structured representation of the portion of the reference works based on the set of concepts associated with the portion of the reference works. For example, the structured representations of the reference works may be obtained using methods similar to those discussed in operations 402 and 404.

At operation 406, a comparison process may be performed using the structured representation of the inference and the structured representations of the reference works to obtain a level of similarity between the inference and the reference works. The comparison process may be performed using methods described with respect to comparison process 228 of FIG. 2B and/or by other methods. The structured representations may include, for example, graph-structured data models (e.g., graphs), and the graphs may be analyzed with respect to one another at various levels of granularity using any graph similarity method.

For example, performing the comparison process may include performing a sub-graph analysis of the structured representation of the inference with respect to portions of the structured representations of the reference works. The sub-graph analysis may be performed using an algorithm that aligns (two or more) graphs in a manner that optimizes similarity between the graphs. The algorithm may include, for example, a genetic algorithm that may be used to identify similarities between the graphs at a local level (e.g., node-level).

The sub-graph analysis may be performed in order to identify similarities between two or more structured representations that may not be similar at a global level (e.g., when taking into account large numbers of nodes and edges), but that may have high levels of similarity at a local level (e.g., when only taking into account small numbers of nodes and edges). Thus, during the comparison process, a portion of the structured representation of the inference may be identified that substantially matches one of the portions of the structured representations of the reference works.

The level of similarity may indicate a likelihood that the inference plagiarizes the reference works. The level of similarity between the inference and the reference works may be obtained, for example, by (i) overlaying (portions of) the structured representation of the inference onto (portions of) the structured representations of the reference works, (ii) evaluating a function of similarity between the structured representation of the inference and the structured representations of the reference works, (iii) a combination thereof, and/or (iv) by other methods. For example, the function of similarity may include any measures of similarity such as Euclidean distance, Manhattan distance, Hamming distance, and/or cosine similarity.

Overlaying the structured representation of the inference onto the structured representations of the reference works may include aligning sub-graphs of the structured representation of the inference with sub-graphs of the structured representations of the reference works using genetic algorithms and/or other types of search algorithms. Each candidate alignment of sub-graphs may be associated with an alignment score, which may be used to identify substantial matches between the structured representations.

For example, the alignment score may be obtained by evaluating an alignment function based on (i) overlaid node-to-node similarity (e.g., based on a function of similarity), (ii) overlaid edge-to-edge similarity (e.g., based on a function of similarity), (iii) skipped nodes and/or edges of the alignment (e.g., based on a penalty function), and/or (iv) other variables for measuring graph alignment. The alignment score may be used to rank order the candidate alignments according to similarity, and the highest rank ordered sub-graph alignment may be selected as the portion of the structured representation of the inference that substantially matches one of the portions of the structured representations of the reference works.

At operation 408, a determination may be made regarding whether the inference is acceptable based on the level of similarity and a similarity threshold. The determination may be made by (i) obtaining information regarding acceptability of the inference from another entity (e.g., the information indicating whether the inference is acceptable or unacceptable), and/or (ii) obtaining the similarity threshold and comparing the level of similarity to the similarity threshold.

For example, if the level of similarity exceeds the similarity threshold, then the inference may be considered unacceptable, and the method may proceed to operation 412. Otherwise, if the level of similarity does not exceed the similarity threshold, then the inference may be considered acceptable, and the method may proceed to operation 410.

At operation 410, the inference may be provided to a downstream consumer as a computer-implemented service. The inference may be provided to the downstream consumer via (i) transmission via a message, (ii) storing in a storage with subsequent retrieval by the downstream consumer, (iii) a publish-subscribe system where the downstream consumer subscribes to updates from a management entity of the generative inference model thereby causing a copy of the inference to be propagated to the downstream consumer, and/or (iv) other processes. For example, the inference may be provided to the downstream consumer during an inferencing process initiated by the downstream consumer.

The inference may be used (e.g., by the downstream consumer) to provide and/or facilitate provision of a portion of the desired computer-implemented services. For example, the inference be consumed by a downstream consumer, and/or provided to (e.g., stored at) a data center for future use.

The method may end following operation 410.

Returning to operation 408, the method may proceed to operation 412 following operation 408 when the inference is considered unacceptable.

At operation 412, performance of an action set may be initiated to manage an impact of the level of similarity between the inference and the reference works. Performance of the action set may be initiated by providing instructions for performing an action of the action set to an entity that may execute the instructions. Initiating the action set may also include performing an action of the action set.

Performing the action set may include (i) preventing provision of the inference to the downstream consumer, (ii) obtaining a description of similarities between the inference and the reference works, (iii) performing at least one action that modifies operation and/or use of the generative inference model to reduce a likelihood that a future inference generated using the generative inference model and the ingest data plagiarized the reference works, and/or (iv) performing other actions.

Preventing provision of the inference to the downstream consumer may include (i) flagging the inference as unacceptable, (ii) interrupting transfer of the inference to the downstream consumer, and/or (iii) notifying the downstream consumer that the inference may not be provided.

Obtaining a description of similarities between the inference and the reference works may include (i) reading the description from storage, (ii) receiving the description (e.g., from another device), (iii) generating the description, and/or (iv) via other methods. For example, generating the description may include (i) identifying portions of the structured representation of the inference and the structured representations of the reference works that substantially match, and (ii) providing the portions to a knowledge graph to text generator to obtain a human interpretable description of the identified portions.

Performing the at least one action that modifies operation and/or use of the generative inference model may include (i) retraining and/or fine-tuning the generative inference model and/or (ii) limiting or preventing use of the generative inference model.

The method may end following operation 412.

Thus, using the method shown in FIG. 4, embodiments disclosed herein may manage operation of a generative inference model in accordance with laws, regulations, and/or policies that may regulate levels of similarities between inferences generated using the generative inference model and reference works. The operation of the generative inference models may be managed based on the levels of similarities in a manner that increases the likelihood of providing desired computer-implemented services using the generative inference models.

Any of the components illustrated in FIGS. 1-3 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a generative inference model, the method comprising:
obtaining an inference generated using the generative inference model and ingest data;
analyzing the inference using a schema to obtain a set of concepts displayed by the inference;
obtaining a structured representation of the inference based on the set of concepts;
performing a comparison process using the structured representation of the inference and structured representations of reference works to obtain a level of similarity between the inference and the reference works;
making a determination regarding whether the inference is acceptable based on the level of similarity and a similarity threshold; and
in a first instance of the determination where the inference is acceptable:
providing the inference to a downstream consumer as a computer-implemented service; and
in a second instance of the determination where the inference is unacceptable:
initiating performance of an action set to manage an impact of the level of similarity between the inference and the reference works.

2. The method of claim 1, wherein the generative inference model is trained to generate human interpretable text when prompted using the ingest data, the human interpretable text being responsive to a request indicated by the ingest data.

3. The method of claim 1, wherein the schema is adapted to facilitate identification of at least one of:
a location indicated by the inference;
a character indicated by the inference;
an object indicated by the inference; and
a law of nature indicated by the inference.

4. The method of claim 1, wherein the structured representation of the inference comprises a graph-structured data model that specifies relationships between concepts of the set of concepts, the graph-structured data model comprising nodes and edges, and the edges being based on the relationships between the concepts associated with the edges.

5. The method of claim 1, wherein performing the comparison process comprises:
performing a sub-graph analysis of the structured representation of the inference with respect to portions of the structured representations of the reference works to identify whether a portion of the structured representation of the inference substantially matches one of the portions of the structured representations of the reference works.

6. The method of claim 1, further comprising:
prior to performing the comparison process:
for a portion of the reference works:
analyzing the portion of the reference works to obtain a set of concepts associated with the portion of the reference works; and
obtaining a structured representation of the portion of the reference works based on the set of concepts associated with the portion of the reference works.

7. The method of claim 1, wherein the level of similarity indicates a likelihood that the inference plagiarizes the reference works.

8. The method of claim 1, wherein the action set comprises obtaining a description of similarities between the inference and the reference works.

9. The method of claim 1, wherein the action set comprises preventing provision of the inference to the downstream consumer.

10. The method of claim 1, wherein the action set comprises at least one action that, when performed, modifies operation and/or use of the generative inference model to reduce a likelihood that a future inference generated using the generative inference model and the ingest data plagiarizes the reference works.

11. A non-transitory machine-readable medium having instructions stored therein, which when executed by a processor, cause the processor to perform operations for managing a generative inference model, the operations comprising:
obtaining an inference generated using the generative inference model and ingest data;
analyzing the inference using a schema to obtain a set of concepts displayed by the inference;
obtaining a structured representation of the inference based on the set of concepts;
performing a comparison process using the structured representation of the inference and structured representations of reference works to obtain a level of similarity between the inference and the reference works;
making a determination regarding whether the inference is acceptable based on the level of similarity and a similarity threshold; and
in a first instance of the determination where the inference is acceptable:
providing the inference to a downstream consumer as a computer-implemented service; and
in a second instance of the determination where the inference is unacceptable:
initiating performance of an action set to manage an impact of the level of similarity between the inference and the reference works.

12. The non-transitory machine-readable medium of claim 11, wherein the generative inference model is trained to generate human interpretable text when prompted using the ingest data, the human interpretable text being responsive to a request indicated by the ingest data.

13. The non-transitory machine-readable medium of claim 11, wherein the schema is adapted to facilitate identification of at least one of:
a location indicated by the inference;
a character indicated by the inference;
an object indicated by the inference; and
a law of nature indicated by the inference.

14. The non-transitory machine-readable medium of claim 11, wherein the structured representation of the inference comprises a graph-structured data model that specifies relationships between concepts of the set of concepts, the graph-structured data model comprising nodes and edges, and the edges being based on the relationships between the concepts associated with the edges.

15. The non-transitory machine-readable medium of claim 11, wherein performing the comparison process comprises:
performing a sub-graph analysis of the structured representation of the inference with respect to portions of the structured representations of the reference works to identify whether a portion of the structured representation of the inference substantially matches one of the portions of the structured representations of the reference works.

16. A data processing system, comprising:
a processor; and
a memory coupled to the processor to store instructions, which when executed by the processor, cause the processor to perform operations for managing a generative inference model, the operations comprising:
obtaining an inference generated using the generative inference model and ingest data,
analyzing the inference using a schema to obtain a set of concepts displayed by the inference,
obtaining a structured representation of the inference based on the set of concepts,
performing a comparison process using the structured representation of the inference and structured representations of reference works to obtain a level of similarity between the inference and the reference works,
making a determination regarding whether the inference is acceptable based on the level of similarity and a similarity threshold, and
in a first instance of the determination where the inference is acceptable:
providing the inference to a downstream consumer as a computer-implemented service, and
in a second instance of the determination where the inference is unacceptable:
initiating performance of an action set to manage an impact of the level of similarity between the inference and the reference works.

17. The data processing system of claim 16, wherein the generative inference model is trained to generate human interpretable text when prompted using the ingest data, the human interpretable text being responsive to a request indicated by the ingest data.

18. The data processing system of claim 16, wherein the schema is adapted to facilitate identification of at least one of:
a location indicated by the inference;
a character indicated by the inference;
an object indicated by the inference; and
a law of nature indicated by the inference.

19. The data processing system of claim 16, wherein the structured representation of the inference comprises a graph-structured data model that specifies relationships between concepts of the set of concepts, the graph-structured data model comprising nodes and edges, and the edges being based on the relationships between the concepts associated with the edges.

20. The data processing system of claim 16, wherein performing the comparison process comprises:
performing a sub-graph analysis of the structured representation of the inference with respect to portions of the structured representations of the reference works to identify whether a portion of the structured representation of the inference substantially matches one of the portions of the structured representations of the reference works.
